(19) United States
(12) Patent Application Publication
(10) Pub. No.: US 2011/0068740 A1
(43) Pub. Date: Mar. 24, 2011

(54) POWER SUPPLY SYSTEM FOR VEHICLE, ELECTRIC VEHICLE HAVING THE SAME, AND METHOD OF CONTROLLING POWER SUPPLY SYSTEM FOR VEHICLE

(75) Inventor: Wanleng Ang, Toyota-shi (JP)

(73) Assignee: Toyota Jidosha Kabushiki Kaisha, Toyota-Shi (JP)

(21) Appl. No.: 12/889,880

(22) Filed: Sep. 24, 2010

(30) Foreign Application Priority Data
Sep. 24, 2009 (JP) JP2009-218685

(51) Int. Cl. H02J 7/02

(52) U.S. Cl. 320/109; 180/65.21

(57) ABSTRACT

A power supply system for a vehicle, configured to be chargeable by a power supply outside the vehicle, includes: a rechargeable electrical storage device; a charger configured to charge the electrical storage device with electric power supplied from the power supply outside the vehicle; a voltage converter configured to convert voltage of electric power output from the electrical storage device and to supply the converted electric power to an auxiliary load; and a controller controlling the voltage converter. The controller includes a remaining time estimation unit estimating a remaining time up to completion of charging of the electrical storage device by the charger and a control unit, when the estimated remaining time is longer than a predetermined period of time, controlling the voltage converter so that a voltage output from the voltage converter is lower than that during system operation in which the vehicle can travel.

### INCORPORATION BY REFERENCE

The disclosure of Japanese Patent Application No. 2009-218685 filed on Sep. 24, 2009 including the specification, drawings and abstract is incorporated herein by reference in its entirety.

### BACKGROUND OF THE INVENTION

1. Field of the Invention

The invention relates to a power supply system for a vehicle, an electric vehicle equipped with the power supply system, and a method of controlling a power supply system for a vehicle and, more particularly, to a power supply system for a vehicle, which is configured to be chargeable by a power supply outside the vehicle, an electric vehicle equipped with the power supply system, and a method of controlling a power supply system for a vehicle.

2. Description of the Related Art

An electric automobile, a hybrid automobile, a fuel cell automobile, and the like, are known as electric vehicles that is able to drive an electric motor for propelling the vehicle using electric power stored in an in-vehicle electrical storage device, typically, a secondary battery. Then, for these electric vehicles, there is proposed a configuration that the in-vehicle electrical storage device is charged by an external power supply outside the vehicle (hereinafter, charging of the in-vehicle electrical storage device by the external power supply is referred to as “external charging”).

Japanese Patent Application Publication No. 2009-27774 (JP-A-2009-27774) describes a vehicle of which the charging efficiency during external charging is improved. The vehicle includes a battery, a DC/DC converter, an auxiliary battery and a controller. The battery is chargeable by an external power supply. The DC/DC converter steps down the voltage of the battery and then outputs the voltage. The auxiliary battery is charged with the voltage output from the DC/DC converter, and supplies electric power to an auxiliary load. The controller continuously operates the DC/DC converter during operation of the vehicle, and intermittently operates the DC/DC converter during external charging.

The above vehicle intermittently operates the DC/DC converter during external charging, so the electrical storage device may be charged while a loss during external charging is being suppressed (see JP-A-2009-27774).

The technique described in JP-A-2009-27774 is useful in that the DC/DC converter that generates an auxiliary voltage is intermittently operated during external charging to suppress a loss during external charging to thereby make it possible to improve the charging efficiency. However, an unnecessarily high auxiliary voltage may possibly be supplied during operation of the DC/DC converter, and electric power consumed by the auxiliary load increases when the auxiliary voltage is high, so the charging efficiency during external charging may possibly deteriorate.

### SUMMARY OF THE INVENTION

The invention provides a power supply system for a vehicle, which is able to improve the charging efficiency during external charging, an electric vehicle equipped with the power supply system, and a method of controlling a power supply system for a vehicle.

A first aspect of the invention relates to a power supply system for a vehicle, which is configured to be chargeable by a power supply outside the vehicle. The power supply system includes: a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter. The controller includes a) a remaining time estimation unit that estimates a remaining time up to completion of charging of the electrical storage device by the charger and b) a control unit that, when the remaining time estimated by the remaining time estimation unit is longer than a predetermined period of time, controls the voltage converter so that a voltage output from the voltage converter is lower than a voltage output from the voltage converter during system operation in which the vehicle can travel.

A second aspect of the invention relates to a power supply system for a vehicle, which is configured to be chargeable by a power supply outside the vehicle. The power supply system includes: a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter. The controller includes a) an SOC estimation unit that estimates a residual capacity of the electrical storage device and b) a control unit that, during charging of the electrical storage device by the charger, controls the voltage converter so that a voltage output from the voltage converter is lower than a voltage output from the voltage converter during system operation in which the vehicle can travel until the residual capacity estimated by the SOC estimation unit reaches a predetermined amount.

A third aspect of the invention relates to an electric vehicle. The electric vehicle includes: the power supply system according to the first aspect; and an electric motor that uses electric power stored in the electrical storage device to generate driving torque.

A fourth aspect of the invention relates to an electric vehicle. The electric vehicle includes: the power supply system according to the second aspect; and an electric motor that uses electric power stored in the electrical storage device to generate driving torque.

A fifth aspect of the invention relates to a method of controlling a power supply system for a vehicle, which is configured to be chargeable by a power supply outside the vehicle, wherein the power supply system includes a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter. The method includes: estimating a remaining time up to completion of charging of the electrical storage device by the charger; and, when the estimated remaining time is longer than a predetermined period of time, controlling the voltage converter so that a voltage output from the voltage converter is lower than a voltage output from the voltage converter during system operation in which the vehicle can travel.

A sixth aspect of the invention relates to a method of controlling a power supply system for a vehicle, which is configured to be chargeable by a power supply outside the vehicle, wherein the power supply system includes a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter. The method includes: estimating a residual capacity of the electrical storage device; and, during charging of the electrical storage device by the charger, controlling the voltage converter so that a voltage output from the voltage converter is lower than a voltage output from the voltage converter during system operation in which the vehicle can travel until the estimated residual capacity reaches a predetermined amount.

According to the above aspects, the remaining time up to completion of external charging is estimated, and, when the estimated remaining time is longer than the predetermined period of time, the voltage converter is controlled so that the voltage output from the voltage converter is lower than the voltage output from the voltage converter during system operation in which the vehicle can travel. In addition, during external charging, until the residual capacity of the electrical storage device reaches the predetermined amount, the voltage converter is controlled so that the voltage output from the voltage converter is lower than the voltage output from the voltage converter during system operation in which the vehicle can travel. With the above configuration, the voltage output from the voltage converter is controlled to be low up to a predetermined time point immediately before completion of external charging, so electric power consumed by the auxiliary load during external charging is reduced. Thus, according to the aspects of the invention, it is possible to further improve the charging efficiency during external charging.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is an overall block diagram of a hybrid vehicle illustrated as an example of an electric vehicle according to a first embodiment of the invention;

FIG. 2 is a graph that shows a variation in auxiliary voltage during external charging;

FIG. 3 is a functional block diagram of portions of a controller shown in FIG. 1, related to control over a DC/DC converter during external charging;

FIG. 4 is a flowchart for illustrating control, executed by the controller shown in FIG. 1, over the DC/DC converter during external charging;

FIG. 5 is a graph that shows a variation in auxiliary voltage during external charging according to a second embodiment;

FIG. 6 is a functional block diagram of portions of a controller according to the second embodiment, related to control over a DC/DC converter during external charging; and

FIG. 7 is a flowchart for illustrating control, executed by the controller according to the second embodiment, over the DC/DC converter during external charging.

### DETAILED DESCRIPTION OF EMBODIMENTS

Hereinafter, embodiments of the invention will be described in detail with reference to the accompanying drawings. Note that like reference numerals denote the same or corresponding portions in the drawings, and the description thereof will not be repeated.

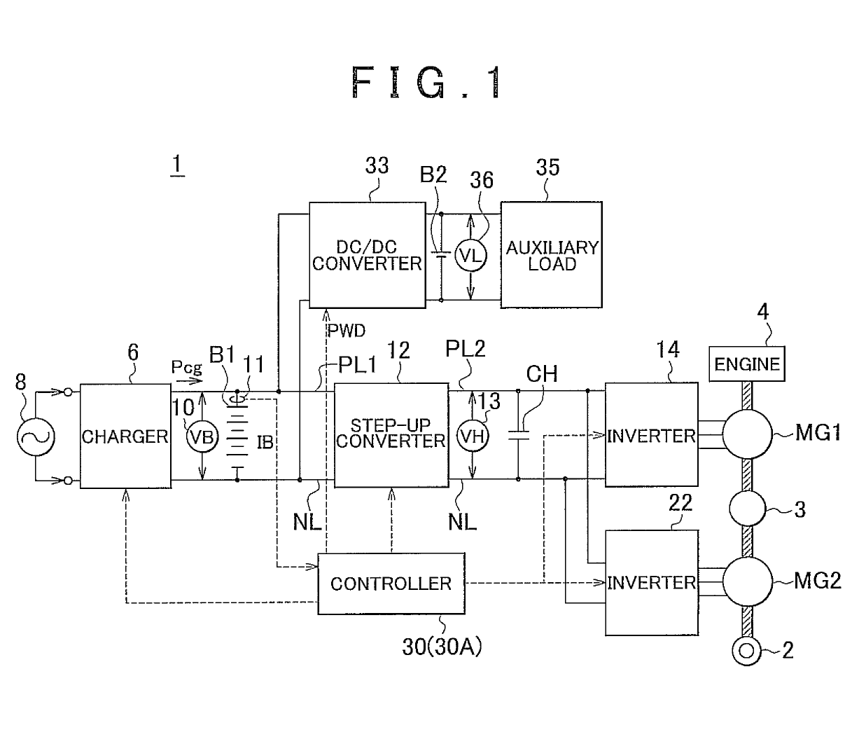

FIG. 1 is an overall block diagram of a hybrid vehicle illustrated as an example of an electric vehicle according to a first embodiment of the invention. As shown in FIG. 1, the hybrid vehicle 1 includes an electrical storage device B1, a step-up converter 12, a smoothing capacitor CH, inverters 14 and 22, motor generators MG1 and MG2, an engine 4, a power split device 3, and a drive wheel 2. In addition, the hybrid vehicle 1 further includes a charger 6, a DC/DC converter 33, an auxiliary battery B2, an auxiliary load 35, voltage sensors 10, 13 and 36, a current sensor 11 and a controller 30.

The electrical storage device B1 is connected between a positive electrode line PL1 and a negative electrode line NL. The step-up converter 12 is provided between the electrical storage device B1 and the inverters 14 and 22. The inverters 14 and 22 are connected to a positive electrode line PL2 and the negative electrode line NL. The DC/DC converter 33 is connected to the positive electrode line PL1 and the negative electrode line NL. The auxiliary battery B2 and the auxiliary load 35 are connected to the DC/DC converter 33.

The electrical storage device B1 is a rechargeable direct-current power supply, and is, for example, formed of a nickel metal hydride secondary battery or a lithium ion secondary battery. The electrical storage device B1 supplies electric power to the step-up converter 12 and the DC/DC converter 33. In addition, the electrical storage device B1 is charged by the step-up converter 12 with electric power generated by the motor generator MG1 and/or the motor generator MG2. Furthermore, the electrical storage device B1 is charged by the charger 6 when the hybrid vehicle 1 is charged by an external power supply 8 (for example, a commercial system power supply) (during external charging). Note that a large-capacitance capacitor may be used as the electrical storage device B1, and, as long as an electric power buffer is able to temporarily store electric power generated by the motor generators MG1 and/or MG2 or electric power supplied from the external power supply 8 and to supply the stored electric power to the step-up converter 12 and the DC/DC converter 33, any electric power buffer is applicable.

The step-up converter 12 steps up the voltage between the positive electrode line PL2 and the negative electrode line NL to the voltage between the positive electrode line PL1 and the negative electrode line NL (voltage of the electrical storage device B1) or above on the basis of a control signal received from the controller 30. The step-up converter 12 is, for example, formed of a current reversible direct-current chopper circuit that has a reactor for storing energy. The smoothing capacitor CH smoothes the voltage between the positive electrode line PL2 and the negative electrode line NL. The positive electrode line PL2 and the negative electrode line NL are arranged between the step-up converter 12 and the inverters 14 and 22.

The inverter 14 drives the motor generator MG1 on the basis of a control signal received from the controller 30. In addition, the inverter 22 drives the motor generator MG2 on the basis of a control signal received from the controller 30. Each of the inverters 14 and 22 is, for example, formed of a three-phase bridge circuit that has a U-phase arm, a V-phase arm and a W-phase arm.

Each of the motor generators MG1 and MG2 is an alternating-current electric rotating machine, and is, for example, formed of a three-phase alternating-current synchronous electric motor in which a permanent magnet is embedded in a rotor. The rotary shaft of the motor generator MG1 is connected to the power split device 3, and the rotary shaft of the motor generator MG2 is coupled to the drive wheel 2. The power split device 3 is formed of a planetary gear that includes a sun gear, pinion gears, a planetary carrier and a ring gear. Then, the rotary shaft of the motor generator MG1, the crankshaft of the engine 4 and a drive shaft coupled to the drive wheel 2 are connected to the power split device 3, and the power split device 3 distributes the output of the engine 4 between the motor generator MG1 and the drive wheel 2.

The charger 6 converts electric power, supplied from the external power supply 8, into a predetermined charging voltage on the basis of a control signal received from the controller 30 during external charging. Then, electric power converted in voltage is supplied by the charger 6 to the electrical storage device B1. Thus, the electrical storage device B1 is charged. The charger 6 is, for example, formed of an AC/DC converter.

The DC/DC converter 33 steps down the output voltage to an auxiliary voltage lower than the voltage between the positive electrode line PL1 and the negative electrode line NL (voltage of the electrical storage device B1) on the basis of a control signal PWD received from the controller 30. The auxiliary battery B2 is an electric power buffer that temporarily stores auxiliary electric power output from the DC/DC converter 33, and is, for example, formed of a lead-acid battery. The auxiliary load 35 includes various auxiliaries mounted on the vehicle. Note that only part of auxiliaries, such as the controller 30 that executes charging control and a necessary minimum display function, operate during external charging by the charger 6, and the magnitude of a load of the auxiliary load 35 during external charging is smaller than a load of the auxiliary load 35 during system operation in which the vehicle can travel.

The voltage sensor 10 detects the voltage between the positive electrode line PL1 and the negative electrode line NL, that is, the voltage VB of the electrical storage device B1. The current sensor 11 detects the current IB input to or output from the electrical storage device B1. The voltage sensor 13 detects the voltage VH between the positive electrode line PL2 and the negative electrode line NL. The voltage sensor 36 detects the voltage output from the DC/DC converter 33, that is, an auxiliary voltage VL. Then, values detected by the sensors are transmitted to the controller 30.

The controller 30 generates a control signal for driving the step-up converter 12 and control signals for driving the motor generators MG1 and MG2, and outputs those generated signals to the step-up converter 12 and the inverters 14 and 22, respectively. In addition, during external charging, the controller 30 generates a control signal for driving the charger 6, and outputs the generated signal to the charger 6.

Furthermore, the controller 30 generates a control signal PWD for driving the DC/DC converter 33, and outputs the generated control signal PWD to the DC/DC converter 33. Here, during external charging by the charger 6, the controller 30 generates a control signal PWD so that the voltage output from the DC/DC converter 33 (that is, auxiliary voltage VL) is lower than the voltage output from the DC/DC converter 33 during system operation in which the vehicle can travel.

Furthermore, the controller 30 estimates a remaining time Tb up to completion of external charging. When the controller 30 determines that completion of external charging will come soon on the basis of the remaining time Tb, the controller 30 generates a control signal PWD so that the voltage output from the DC/DC converter 33 returns to the level during system operation. Note that the remaining time Tb may be, for example, calculated from the residual capacity (hereinafter, referred to as “state of charge (SOC)”) of the electrical storage device B1 and the charging rate of the charger 6. The configuration of the controller 30 will be described later in detail.

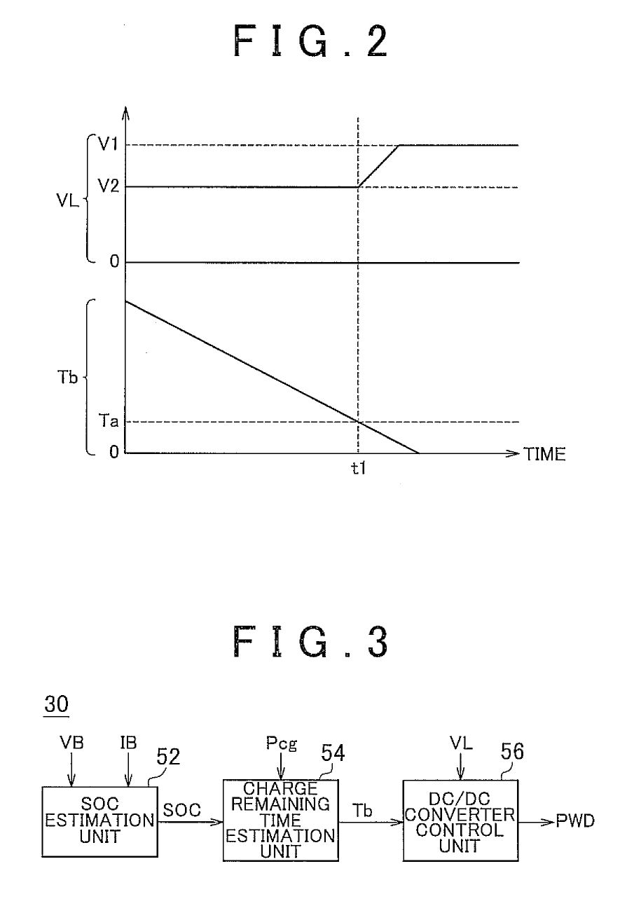

FIG. 2 is a graph that shows a variation in auxiliary voltage VL during external charging. As shown in FIG. 2, during external charging, the auxiliary voltage VL is regulated by the DC/DC converter 33 (FIG. 1) to a voltage V2 that is lower than a voltage V1 during system operation in which the vehicle can travel. Note that the voltage V2 is set to a minimum level at which the auxiliary load 35 (FIG. 1) that operates during external charging is normally operable. By so doing, electric power consumed by the auxiliary load 35 during external charging is reduced and, as a result, the efficiency of external charging improves.

Then, at time t1, as the remaining time Tb reaches a predetermined threshold Ta that indicates that completion of external charging will come soon, the auxiliary voltage VL is returned to the voltage V1 during system operation in which the vehicle can travel. By so doing, the auxiliary battery B2 may be sufficiently charged using electric power supplied from the external power supply 8 (FIG. 1) in preparation for the next traveling.

FIG. 3 is a functional block diagram of portions of the controller 30 shown in FIG. 1, related to control over the DC/DC converter 33 during external charging. The controller 30 includes an SOC estimation unit 52, a charge remaining time estimation unit 54 and a DC/DC converter control unit 56.

The SOC estimation unit 52 estimates the SOC of the electrical storage device B1 on the basis of the detected voltage VB received from the voltage sensor 10 (FIG. 1) and the detected current IB received from the current sensor 11 (FIG. 1). Various known methods may be used as a method of estimating the SOC.

The charge remaining time estimation unit 54 estimates the remaining time Tb up to completion of charging of the electrical storage device B1 by the charger 6 on the basis of the estimated SOC received from the SOC estimation unit 52 and the charging rate Pcg of the charger 6. For example, a charged amount of electric power up to a fully charged state is calculated on the basis of the capacity and SOC of the electrical storage device B1, and then the calculated charged amount of electric power is divided by the charging rate Pcg. By so doing, the remaining time Tb may be calculated. Note that the charging rate Pcg may be a target value or may be a value actually detected by a sensor.

When the remaining time Tb received from the charge remaining time estimation unit 54 is longer than the threshold Ta (FIG. 2), the DC/DC converter control unit 56 generates a control signal PWD for driving the DC/DC converter 33 and then outputs the control signal PWD to the DC/DC converter 33 so that the voltage output from the DC/DC converter 33 (auxiliary voltage VL) is lower than the voltage output from the DC/DC converter 33 during system operation in which the vehicle can travel.

In addition, when the remaining time Tb for charging is shorter than or equal to the threshold Ta, the DC/DC converter control unit 56 generates a control signal PWD and then outputs the control signal PWD to the DC/DC converter 33 so that the voltage output from the DC/DC converter 33 (auxiliary voltage VL) returns to the level during system operation in which the vehicle can travel.

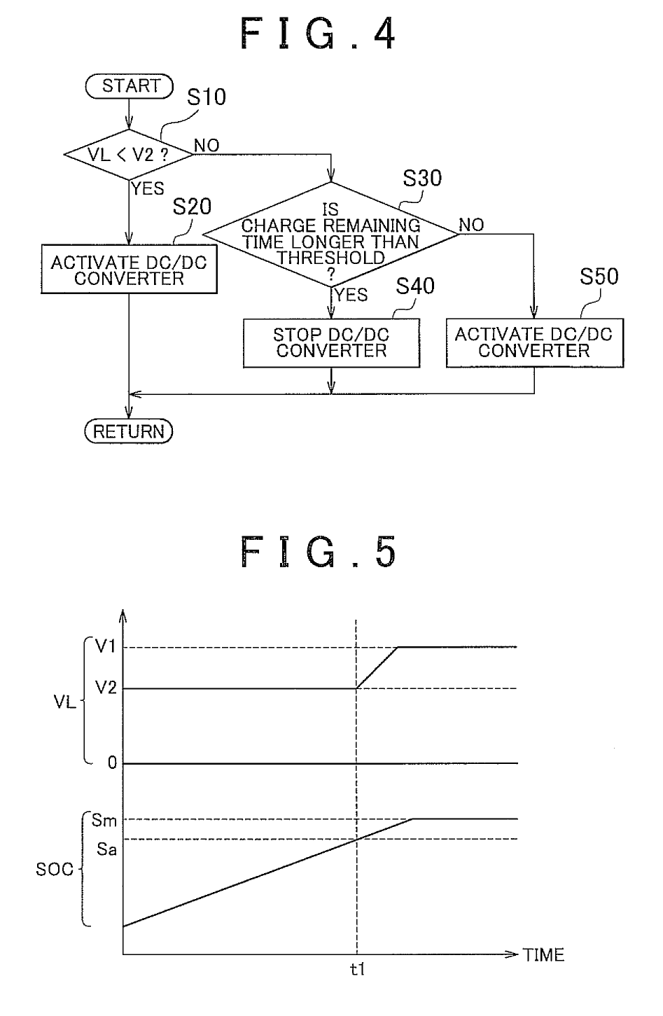

FIG. 4 is a flowchart for illustrating control, executed by the controller 30, over the DC/DC converter 33 during external charging. Note that the process of the flowchart is executed during external charging at a regular time interval or each time a predetermined condition is satisfied.

The controller 30 determines whether the auxiliary voltage VL detected by the voltage sensor 36 (FIG. 1) is lower than the voltage V2 (FIG. 2) (step S10). Note that as described with reference to FIG. 2, the voltage V2 is lower than the voltage V1 during system operation in which the vehicle can travel, and is set to a minimum level at which the auxiliary load 35 (FIG. 1) that operates during external charging is normally operable.

When it is determined that the auxiliary voltage VL is lower than the voltage V2 (YES in step S10), the controller 30 generates a control signal PWD for driving the DC/DC converter 33 and then outputs the control signal PWD to the DC/DC converter 33 to thereby activate the DC/DC converter 33 (step S20). When the DC/DC converter 33 is activated, the auxiliary voltage VL increases.

On the other hand, when it is determined in step S10 that the auxiliary voltage VL is higher than or equal to the voltage V2 (NO in step S10), the controller 30 determines whether the remaining time Tb for external charging by the charger 6 is longer than the threshold Ta (FIG. 2) (step S30). Note that, as described with reference to FIG. 2, the threshold Ta is set for determining that completion of external charging will come soon.

Then, when it is determined in step S30 that the remaining time Tb is longer than the threshold Ta (YES in step S30), the controller 30 generates a control signal PWD for stopping the DC/DC converter 33 and then outputs the control signal PWD to the DC/DC converter 33 to thereby stop the DC/DC converter 33 (step S40). As the DC/DC converter 33 stops, the auxiliary voltage VL decreases. Through the processes from step S10 to step S40, when the remaining time Tb is longer than the threshold Ta, the auxiliary voltage VL is controlled to the voltage V2.

On the other hand, when it is determined in step S30 that the remaining time Tb is shorter than or equal to the threshold Ta (NO in step S30), the controller 30 generates a control signal PWD for driving the DC/DC converter 33 and then outputs the control signal PWD to the DC/DC converter 33 to thereby activate the DC/DC converter 33 (step S50). Note that, when the DC/DC converter 33, for example, receives a control signal PWD for driving the DC/DC converter 33 from the controller 30, the DC/DC converter 33 controls the output voltage to the voltage V1 (FIG. 2). Thus, when the remaining time Tb is shorter than or equal to the threshold Ta, the auxiliary voltage VL returns to the voltage V1.

As described above, in the first embodiment, the remaining time Tb up to completion of external charging is estimated, and, when the estimated remaining time Tb is longer than the threshold Ta, the DC/DC converter 33 is controlled so that the voltage output from the DC/DC converter 33 (auxiliary voltage VL) is lower than the voltage output from the DC/DC converter 33 during system operation in which the vehicle can travel. By so doing, the voltage output from the DC/DC converter 33 is controlled to be low until a predetermined time point before completion of external charging to thereby reduce electric power consumed by the auxiliary load 35 during external charging. Thus, according to the first embodiment, it is possible to further improve the charging efficiency during external charging.

A second embodiment of the invention will be described with respect to FIGS. 5 to 7. In the first embodiment, the remaining time Tb up to completion of external charging is estimated, and, when the remaining time Tb reaches the threshold Ta, the auxiliary voltage VL is returned to V1 at the normal level. In the second embodiment, during external charging, as the SOC reaches a predetermined threshold near a fully charged state, the auxiliary voltage VL is returned to V1 at the normal level.

The overall configuration of an electric vehicle according to the second embodiment is the same as that of the electric vehicle according to the first embodiment shown in FIG. 1.

FIG. 5 is a graph that shows a variation in auxiliary voltage VL during external charging according to the second embodiment. As shown in FIG. 5, during external charging, the auxiliary voltage VL is regulated by the DC/DC converter 33 (FIG. 1) to the voltage V2 that is lower than the voltage V1 during system operation in which the vehicle can travel.

Then, at time t1, as the SOC of the electrical storage device B1 reaches a predetermined threshold Sa that indicates that the electrical storage device B1 is close to a fully charged state Sm, the auxiliary voltage VL is returned to the voltage V1 during system operation in which the vehicle can travel.

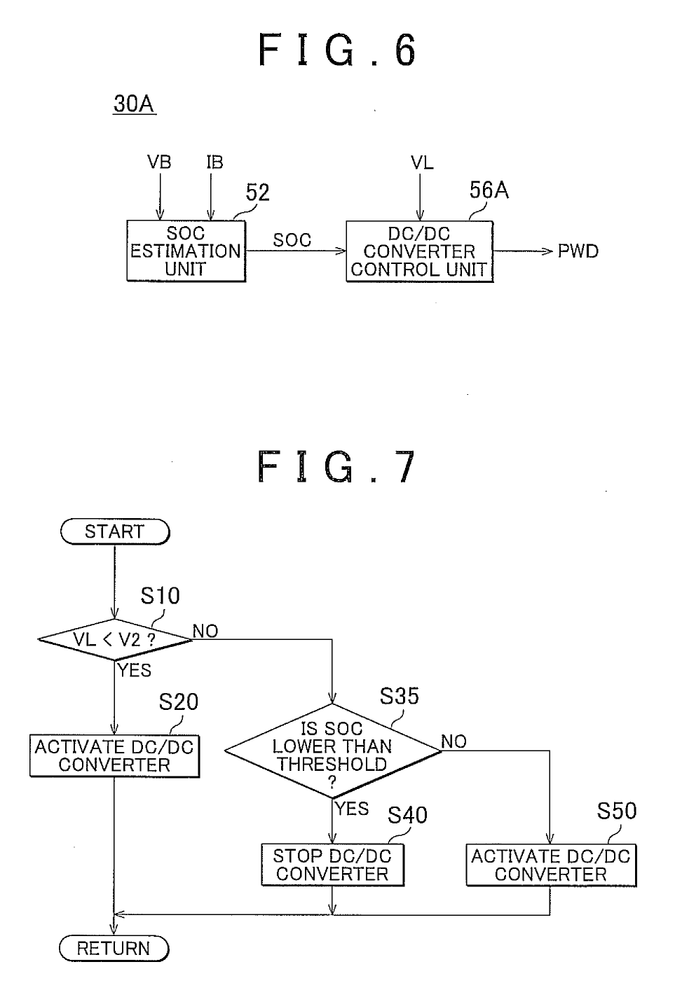

FIG. 6 is a functional block diagram of portions of a controller 30A according to the second embodiment, related to control over the DC/DC converter 33 during external charging. The controller 30A includes the SOC estimation unit 52 and a DC/DC converter control unit 56A. The SOC estimation unit 52 is configured as described with reference to FIG. 3 in the first embodiment.

When the estimated SOC received from the SOC estimation unit 52 is lower than the threshold Sa (FIG. 5), the DC/DC converter control unit 56A generates a control signal PWD for driving the DC/DC converter 33 and then outputs the control signal PWD to the DC/DC converter 33 so that the voltage output from the DC/DC converter 33 (auxiliary voltage VL) is lower than the voltage output from the DC/DC converter 33 during system operation in which the vehicle can travel.

In addition, when the estimated SOC received from the SOC estimation unit 52 reaches the threshold Sa, the DC/DC converter control unit 56A generates a control signal PWD and then outputs the control signal PWD to the DC/DC converter 33 so that the voltage output from the DC/DC converter 33 (auxiliary voltage VL) returns to the level during system operation in which the vehicle can travel.

FIG. 7 is a flowchart for illustrating control, executed by the controller 30A according to the second embodiment, over the DC/DC converter 33 during external charging. Note that the process of the flowchart is executed during external charging at a regular time interval or each time a predetermined condition is satisfied.

The flowchart includes step S35 instead of step S30 in the flowchart shown in FIG. 4. When it is determined in step S10 that the auxiliary voltage VL is higher than or equal to the voltage V2 (NO in step S10), the controller 30A determines whether the SOC of the electrical storage device B1 is lower than the threshold Sa (FIG. 5) (step S35). Note that as described with reference to FIG. 5, the threshold Sa is set for determining that the electrical storage device B1 is close to the fully charged state Sm.

Then, when it is determined in step S35 that the SOC is lower than the threshold Sa (YES in step S35), the process proceeds to step S40, and the controller 30A generates a control signal PWD for stopping the DC/DC converter 33 and then outputs the control signal PWD to the DC/DC converter 33 to thereby stop the DC/DC converter 33.

On the other hand, when it is determined in step S35 that the SOC is higher than or equal to the threshold Sa (NO in step S35), the process proceeds to step S50, and the controller 30A generates a control signal PWD for driving the DC/DC converter 33 and then outputs the control signal PWD to the DC/DC converter 33 to thereby activate the DC/DC converter 33.

As described above, in the second embodiment, during external charging, until the SOC of the electrical storage device B1 reaches the threshold Sa, the DC/DC converter 33 is controlled so that the voltage output from the DC/DC converter 33 (auxiliary voltage VL) is lower than the voltage output from the DC/DC converter 33 during system operation in which the vehicle can travel. By so doing, the voltage output from the DC/DC converter 33 is controlled to be low until a predetermined time point before completion of external charging to thereby reduce electric power consumed by the auxiliary load 35 during external charging. Thus, according to the second embodiment as well, it is possible to further improve the charging efficiency during external charging.

Note that the above embodiments describe a series/parallel-type hybrid vehicle that uses the power split device 3 to split the power of the engine 4 to thereby make it possible to transmit the power to the drive wheel 2 and the motor generator MG1 as an example of the electric vehicle; however, the aspect of the invention may also be applied to a hybrid vehicle of another type. For example, the aspect of the invention may also be applied to a so-called series-type hybrid vehicle that uses the engine 4 for driving only the motor generator MG1 and that uses only the motor generator MG2 to generate driving force of the vehicle, a hybrid vehicle that collects only regenerative energy from kinetic energy generated by the engine as electric energy or a motor assist-type hybrid vehicle that uses an engine as a main power source and that, where necessary, uses a motor for assisting the engine.

In addition, the aspect of the invention may also be applied to an electric automobile that includes no engine 4 and that travels on only electric power or a fuel cell automobile that further includes a fuel cell in addition to the electrical storage device B1 as a direct-current power supply. In addition, the aspect of the invention may also be applied to an electric vehicle that includes no step-up converter 12.

Note that, in the above description, the DC/DC converter 33 may be regarded as a “voltage converter” according to the aspect of the invention, the SOC estimation unit 52 may be regarded as an “SOC estimation unit” according to the aspect of the invention, the charge remaining time estimation unit 54 may be regarded as a “remaining time estimation unit” according to the aspect of the invention. In addition, the DC/DC converter control units 56 and 56A may be regarded as a “control unit” according to the aspect of the invention, and the motor generator MG2 may be regarded as an “electric motor” according to the aspect of the invention.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A power supply system for a vehicle, which is configured to be chargeable by a power supply outside the vehicle, comprising:
a rechargeable electrical storage device;
a charger that is configured to charge the electrical storage device with electric power supplied from the power supply outside the vehicle;
a voltage converter that is configured to convert voltage of electric power output from the electrical storage device and to supply the converted electric power to an auxiliary load; and
a controller that controls the voltage converter, wherein
the controller includes a) a remaining time estimation unit that estimates a remaining time up to completion of charging of the electrical storage device by the charger and b) a control unit that, when the remaining time estimated by the remaining time estimation unit is longer than a predetermined period of time, controls the voltage converter so that a voltage output from the voltage converter is lower than a voltage output from the voltage converter during system operation in which the vehicle can travel.

2. The power supply system according to claim 1, wherein, when the remaining time estimated by the remaining time estimation unit is shorter than the predetermined period of time, the control unit controls the voltage converter so that the voltage output from the voltage converter returns to the voltage output from the voltage converter during system operation.

3. The power supply system according to claim 1, wherein the voltage output from the voltage converter, which is controlled to be lower than the voltage output from the voltage converter during system operation, is a minimum voltage at which the auxiliary load is normally operable.

4. The power supply system according to claim 3, wherein, when the voltage output from the voltage converter is lower than the minimum voltage at which the auxiliary load is normally operable, the control unit steps up the voltage output from the voltage converter to the minimum voltage at which the auxiliary load is normally operable.

5. A power supply system for a vehicle, which is configured to be chargeable by a power supply outside the vehicle, comprising:
a rechargeable electrical storage device;
a charger that is configured to charge the electrical storage device with electric power supplied from the power supply outside the vehicle;
a voltage converter that is configured to convert voltage of electric power output from the electrical storage device and to supply the converted electric power to an auxiliary load; and
a controller that controls the voltage converter, wherein
the controller includes a) an SOC estimation unit that estimates a residual capacity of the electrical storage device and b) a control unit that, during charging of the electrical storage device by the charger, controls the voltage converter so that a voltage output from the voltage converter is lower than a voltage output from the voltage converter during system operation in which the vehicle can travel until the residual capacity estimated by the SOC estimation unit reaches a predetermined amount.

6. The power supply system according to claim 5, wherein, when the residual capacity estimated by the SOC estimation unit reaches the predetermined amount, the control unit controls the voltage converter so that the voltage output from the voltage converter returns to the voltage output from the voltage converter during system operation.

7. The power supply system according to claim 5, wherein the voltage output from the voltage converter, which is controlled to be lower than the voltage output from the voltage converter during system operation, is a minimum voltage at which the auxiliary load is normally operable.

8. The power supply system according to claim 7, wherein, when the voltage output from the voltage converter is lower than the minimum voltage at which the auxiliary load is normally operable, the control unit steps up the voltage output from the voltage converter to the minimum voltage at which the auxiliary load is normally operable.

9. An electric vehicle comprising:
the power supply system according to claim 1; and
an electric motor that uses electric power stored in the electrical storage device to generate driving torque.

10. An electric vehicle comprising:
the power supply system according to claim 5; and
an electric motor that uses electric power stored in the electrical storage device to generate driving torque.

11. A method of controlling a power supply system for a vehicle, which is configured to be chargeable by a power supply outside the vehicle, wherein the power supply system includes a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter, the method comprising:
estimating a remaining time up to completion of charging of the electrical storage device by the charger; and
when the estimated remaining time is longer than a predetermined period of time, controlling the voltage converter so that a voltage output from the voltage converter is lower than a voltage output from the voltage converter during system operation in which the vehicle can travel.

12. A method of controlling a power supply system for a vehicle, which is configured to be chargeable by a power supply outside the vehicle, wherein the power supply system includes a rechargeable electrical storage device; a charger that is configured to charge the electrical storage device with electric power supplied from the power supply outside the vehicle; a voltage converter that is configured to convert voltage of electric power output from the electrical storage device and to supply the converted electric power to an auxiliary load; and a controller that controls the voltage converter, the method comprising:
estimating a residual capacity of the electrical storage device; and
during charging of the electrical storage device by the charger, controlling the voltage converter so that a voltage output from the voltage converter is lower than a voltage output from the voltage converter during system operation in which the vehicle can travel until the estimated residual capacity reaches a predetermined amount.
